(19) United States
(12) Patent Application Publication
(10) Pub. No.: US 2009/0216716 A1
(43) Pub. Date: Aug. 27, 2009

(54) Methods, Apparatuses and Computer Program Products for Providing a Search Form

(75) Inventors: Murali Krishna Punaganti Venkata, Espoo (FI); Kimmo Ramo, Espoo (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation

(21) Appl. No.: 12/036,536

(22) Filed: Feb. 25, 2008

(51) Int. Cl. G06F 7/06

(52) U.S. Cl. 707/3; 707/E17.014

(57) ABSTRACT

A method, apparatus and computer program product are provided for retrieving and utilizing customized vertical search forms. The customized vertical search forms can be customized by various service providers and stored in a customizable forms service to be made available for use by various entities. The customizable forms service can include a form registry and a customization component registry which can facilitate retrieval of a customized vertical search form by a requesting device, such as a mobile terminal. Once retrieved, the requesting device can utilize the customized vertical search to initiate searches undertaken by a service provider linked to the customized vertical search form.

### TECHNOLOGICAL FIELD

Embodiments of the present invention relate generally to content retrieval technology and, more particularly, relate to various methods, apparatuses, systems and computer program products for providing a search form.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies, such as, for example cellular telephone technologies, have addressed related consumer demands, while providing more flexibility and immediacy of information transfer.

Current and future networking technologies continue to facilitate ease of information transfer and convenience to users. One area in which there is a demand to increase the ease of information transfer and convenience to users relates to the provision of information retrieval in networks. For example, information such as audio, video, image content, text, data, etc., may be made available for retrieval between different entities using various communication networks. Accordingly, devices associated with each of the different entities may be placed in communication with each other to locate and affect a transfer of the information. In particular, mechanisms have been developed to enable devices such as mobile terminals to conduct searches for information or content related to a particular query or keyword.

While performing content searches on mobile terminals is currently available, searching can often be difficult due to the limitations associated with screen size and keypad size. Often when conventional searches are utilized, possibly millions of search results may be returned as matches. Given the limitations of mobile terminals, reviewing these results can be cumbersome.

In the personal computer arena, vertical searching has been introduced to target particular content in order to provide more focused search results. A vertical is a specific topic or category, such as books, news, images, music, etc. When a vertical search is undertaken, only results which fit into the particular topic or category, i.e. the vertical, are returned. Searching in this manner can significantly reduce the number and variety of returned search results and provide for a more focused search. For example, some service providers, e.g. Google, Yahoo, MSN, etc. currently provide vertical searches involving books, news, shopping, finance, scholarship, etc. Many of these vertical searches include the use of search forms which incorporate various search fields which are targeted to the associated vertical. For example, a form for a book search may include search fields for title, International Standard Book Number (ISBN), author, publisher, publication date, etc.

However, while these vertical search solutions have been made available in the personal computer realm, similar solutions have not been implemented in the mobile computing realm. This is due in part to the lack of a developed framework for utilizing vertical searching concepts.

Accordingly, it may be advantageous to provide an improved mechanism for assisting consumers when performing searches on mobile terminals using vertical searches. In particular, it may be advantageous to provide vertical searching mechanisms for mobile terminals that facilitate a more simplified means for searching where a more manageable number of search results are returned.

### BRIEF SUMMARY

Various methods, apparatuses, systems and computer program products are therefore provided to generate, store, retrieve and utilize customized vertical search forms. As such, various embodiments of the invention retrieve customized vertical search forms and perform searches using the customized vertical search forms. The customized vertical search forms can include one or more search parameter fields relating to a topic or category defined by a vertical. The vertical can be associated with the customized vertical search form. Further, the customized vertical search form can be customized by a service provider and made available for use via a customizable forms service. The search can be performed by requesting search results from the service provider based on data entered into the search parameter fields, the vertical associated with the customized vertical search form and a link associating the customized vertical search form with the service provider.

In various additional embodiments, a customized vertical search form can be retrieved from the customizable forms service. The customizable forms service can include a form registry where entries for customized vertical search forms are stored for facilitating retrieval of a basic vertical search form. Additionally, the customizable forms service can also include a customization component registry where entries for customized vertical search forms are stored for facilitating retrieval of customizations associated with the customized vertical search form. The basic vertical search form and the customized components can be combined to comprise the customized vertical search form.

In some additional embodiments, the customized vertical search form can be stored in a local storage entity after being retrieved. In this manner, the customized vertical search form can be retrieved from the local storage entity when performing additional searches.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an exemplary embodiment of the present invention;

FIG. 2 is a schematic block diagram of a wireless communications system according to an exemplary embodiment of the present invention;

FIG. 3 is a block diagram of customizable form service system according to an exemplary embodiment of the present invention; and

FIG. 4 is a flowchart of the operations undertaken to retrieve and utilize a search form according to an exemplary embodiment of the present invention.

### DETAILED DESCRIPTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

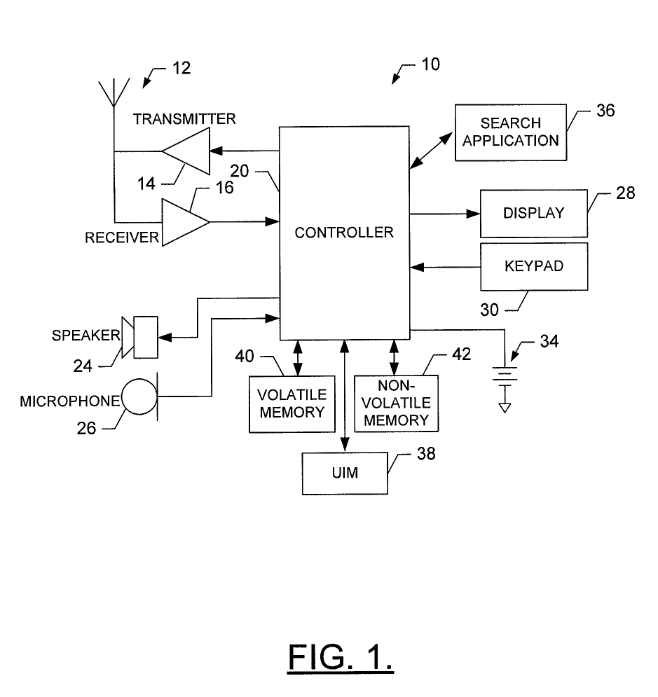

FIG. 1 illustrates a block diagram of a mobile terminal 10 that would benefit from embodiments of the present invention. It should be understood, however, that a mobile telephone as illustrated and hereinafter described is merely illustrative of one type of mobile terminal that would benefit from embodiments of the present invention and, therefore, should not be taken to limit the scope of embodiments of the present invention. While one embodiment of the mobile terminal 10 is illustrated and will be hereinafter described for purposes of example, other types of mobile terminals, such as portable digital assistants (PDAs), pagers, mobile computers, mobile televisions, gaming devices, laptop computers, cameras, video recorders, GPS devices and other types of voice and text communications systems, can readily employ embodiments of the present invention. Furthermore, devices that are not mobile may also readily employ embodiments of the present invention.

The system and method of embodiments of the present invention will be primarily described below in conjunction with mobile communications applications. However, it should be understood that the system and method of embodiments of the present invention can be utilized in conjunction with a variety of other applications, both in the mobile communications industries and outside of the mobile communications industries.

The mobile terminal 10 includes an antenna 12 (or multiple antennae) in operable communication with a transmitter 14 and a receiver 16. The mobile terminal 10 further includes an apparatus, such as a controller 20 or other processing element that provides signals to and receives signals from the transmitter 14 and receiver 16, respectively. The signals include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with fourth-generation (4G) wireless communication protocols or the like.

It is understood that the apparatus such as the controller 20 includes means, such as circuitry, desirable for implementing audio and logic functions of the mobile terminal 10. For example, the controller 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 can additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a microphone 26, a display 28, and a user input interface, all of which are coupled to the controller 20. The user input interface, which allows the mobile terminal 10 to receive data, may include any of a number of devices allowing the mobile terminal 10 to receive data, such as a keypad 30, a touch display (not shown) or other input device. In embodiments including the keypad 30, the keypad 30 may include the conventional numeric (0-9) and related keys (#, *), and other hard and/or soft keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 further includes a battery 34, such as a vibrating battery pack, for powering various circuits that are required to operate the mobile terminal 10, as well as optionally providing mechanical vibration as a detectable output.

The mobile terminal 10 may also include a search application 36. The search application 36 may be any means, device or circuitry embodied in hardware, software, or a combination of hardware and software that is capable of conducting information searches using customized vertical search forms. In this regard, a customized vertical search form can be a compilation of search parameter fields that are associated with a particular vertical. A vertical can be a topic or category, such as books, images, news, etc. The search forms can be customized by a service provider, such as Google, Yahoo, MSN, etc. such that particular search parameter fields and other customizations are included on the form. As such, a vertical search using a search form will search for information within a particular topic or category, i.e. vertical, based upon the search parameters entered into the search parameter fields of the search form. Accordingly, a search of this type can be initiated by search application 36 by retrieving a customized vertical search form and providing for the entry of search parameters in the search parameter fields of the vertical search form. Search application 36 can further initiate the execution of the search. In this regard, in some embodiments, search application 36 may be a browser. Search application 36 can also manage customized vertical search forms by retrieving and storing the search forms. In some embodiments, a separate application, such as form manager application, can handle the management of search forms, i.e. retrieving, storing and updating of search forms. In this regard, in some embodiments, search application 36 may still interact with the customized vertical search form during the initiation of a search request as discussed below.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which can be embedded and/or may be removable. The non-volatile memory 42 can additionally or alternatively comprise an electrically erasable programmable read only memory (EEPROM), flash memory or the like, such as that available from the SanDisk Corporation of Sunnyvale, Calif., or Lexar Media Inc. of Fremont, Calif. The memories can store any of a number of pieces of information, and data, used by the mobile terminal 10 to implement the functions of the mobile terminal 10. For example, the memories can include an identifier, such as an international mobile equipment identification (IMEI) code, capable of uniquely identifying the mobile terminal 10.

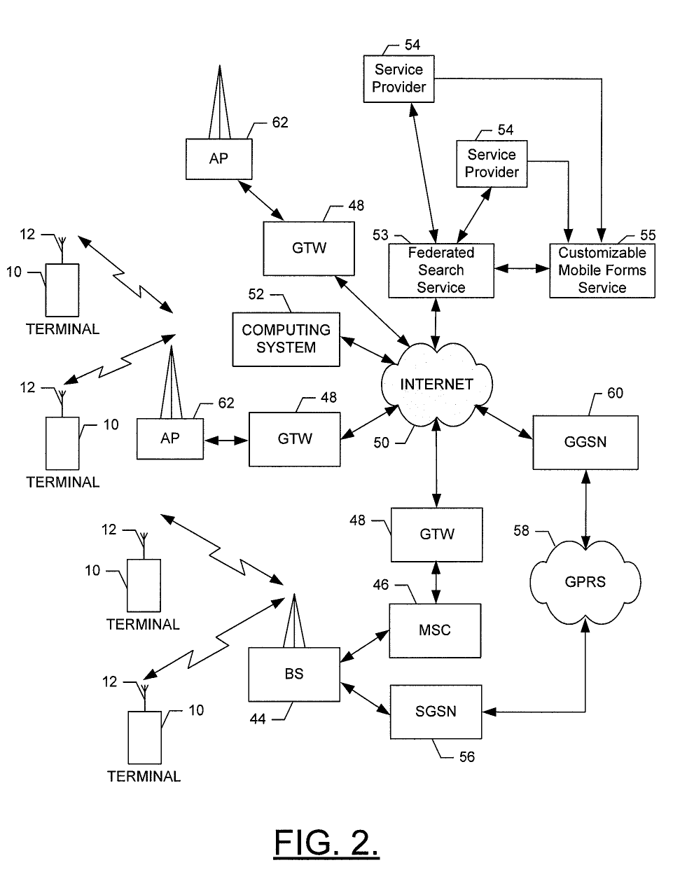

FIG. 2 is a schematic block diagram of a wireless communications system according to an exemplary embodiment of the present invention. Referring now to FIG. 2, an illustration of one type of system that would benefit from embodiments of the present invention is provided. The system includes a plurality of network devices. As shown, one or more mobile terminals 10 may each include an antenna 12 for transmitting signals to and for receiving signals from a base site or base station (BS) 44. The base station 44 may be a part of one or more cellular or mobile networks each of which includes elements required to operate the network, such as a mobile switching center (MSC) 46. As well known to those skilled in the art, the mobile network may also be referred to as a Base Station/MSC/Interworking function (BMI). In operation, the MSC 46 is capable of routing calls to and from the mobile terminal 10 when the mobile terminal 10 is making and receiving calls. The MSC 46 can also provide a connection to landline trunks when the mobile terminal 10 is involved in a call. In addition, the MSC 46 can be capable of controlling the forwarding of messages to and from the mobile terminal 10, and can also control the forwarding of messages for the mobile terminal 10 to and from a messaging center. It should be noted that although the MSC 46 is shown in the system of FIG. 2, the MSC 46 is merely an exemplary network device and embodiments of the present invention are not limited to use in a network employing an MSC.

The MSC 46 can be coupled to a data network, such as a local area network (LAN), a metropolitan area network (MAN), and/or a wide area network (WAN). The MSC 46 can be directly coupled to the data network. In one typical embodiment, however, the MSC 46 is coupled to a gateway device (GTW) 48, and the GTW 48 is coupled to a WAN, such as the Internet 50. In turn, devices such as processing elements (e.g., personal computers, server computers or the like) can be coupled to the mobile terminal 10 via the Internet 50. For example, as explained below, the processing elements can include one or more processing elements associated with a computing system 52 and/or the like as described below.

The BS 44 can also be coupled to a signaling GPRS (General Packet Radio Service) support node (SGSN) 56. As known to those skilled in the art, the SGSN 56 is typically capable of performing functions similar to the MSC 46 for packet switched services. The SGSN 56, like the MSC 46, can be coupled to a data network, such as the Internet 50. The SGSN 56 can be directly coupled to the data network. In a more typical embodiment, however, the SGSN 56 is coupled to a packet-switched core network, such as a GPRS core network 58. The packet-switched core network is then coupled to another GTW 48, such as a GTW GPRS support node (GGSN) 60, and the GGSN 60 is coupled to the Internet 50. In addition to the GGSN 60, the packet-switched core network can also be coupled to a GTW 48. Also, the GGSN 60 can be coupled to a messaging center. In this regard, the GGSN 60 and the SGSN 56, like the MSC 46, may be capable of controlling the forwarding of messages, such as MMS messages. The GGSN 60 and SGSN 56 may also be capable of controlling the forwarding of messages for the mobile terminal 10 to and from the messaging center.

In addition, by coupling the SGSN 56 to the GPRS core network 58 and the GGSN 60, devices such as a computing system 52 may be coupled to the mobile terminal 10 via the Internet 50, SGSN 56 and GGSN 60. In this regard, devices such as the computing system 52 may communicate with the mobile terminal 10 across the SGSN 56, GPRS core network 58 and the GGSN 60. By directly or indirectly connecting mobile terminals 10 and the other devices (e.g., computing system 52, federated search service 53, etc.) to the Internet 50, the mobile terminals 10 may communicate with the other devices and with one another, such as according to the Hypertext Transfer Protocol (HTTP) and/or the like, to thereby carry out various functions of the mobile terminals 10.

Although not every element of every possible mobile network is shown and described herein, it should be appreciated that the mobile terminal 10 may be coupled to one or more of any of a number of different networks through the BS 44. In this regard, the network(s) may be capable of supporting communication in accordance with any one or more of a number of first-generation (1G), second-generation (2G), 2.5G, third-generation (3G), 3.9G, fourth-generation (4G) mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as a UMTS network employing WCDMA radio access technology. Some narrow-band analog mobile phone service (NAMPS), as well as total access communication system (TACS), network(s) may also benefit from embodiments of the present invention, as should dual or higher mode mobile stations (e.g., digital/analog or TDMA/CDMA/analog phones).

The mobile terminal 10 can further be coupled to one or more wireless access points (APs) 62. The APs 62 may comprise access points configured to communicate with the mobile terminal 10 in accordance with techniques such as, for example, radio frequency (RF), Bluetooth (BT), infrared (IrDA) or any of a number of different wireless networking techniques, including wireless LAN (WLAN) techniques such as IEEE 802.11 (e.g., 802.11a, 802.11b, 802.11g, 802.11n, etc.), world interoperability for microwave access (WiMAX) techniques such as IEEE 802.16, and/or ultra wideband (UWB) techniques such as IEEE 802.15 and/or the like. The APs 62 may be coupled to the Internet 50. Like with the MSC 46, the APs 62 can be directly coupled to the Internet 50. In one embodiment, however, the APs 62 are indirectly coupled to the Internet 50 via a GTW 48. Furthermore, in one embodiment, the BS 44 may be considered as another AP 62. As will be appreciated, by directly or indirectly connecting the mobile terminals 10 and the computing system 52, and/or any of a number of other devices, to the Internet 50, the mobile terminals 10 can communicate with one another, the computing system, etc., to thereby carry out various functions of the mobile terminals 10, such as to transmit data, content or the like to, and/or receive content, data or the like from, the computing system 52. As used herein, the terms “data,” “content,” “information” and similar terms may be used interchangeably to refer to data capable of being transmitted, received and/or stored in accordance with embodiments of the present invention. Thus, use of any such terms should not be taken to limit the spirit and scope of embodiments of the present invention.

As will be appreciated, by directly or indirectly connecting the mobile terminals 10 and the computing system 52, the federated search service 53 and/or any of a number of other devices, to the Internet 50, the mobile terminals 10 can communicate with one another, the computing system 52, the federated search service 53, etc., to thereby carry out various functions of the mobile terminals 10, such as to transmit data, content or the like to, and/or receive content, data or the like from, the computing system 52 and/or the federated search service 53, etc.

The federated search service 53, for example, may be embodied as one or more other servers. The federated search service 53 can provide an interface between mobile terminal 10 and customizable mobile forms service 55 or service providers 54. For example, if mobile terminal 10 initiates a search request, or more particularly if search application 36 of mobile terminal 10 initiates a search request, the search request can be received by federated search service 53. In some embodiments, a search request initiated by search application 36 can be directed to a particular service provider 54. In such cases, federated search service 53 may direct the search request to the appropriate service provider 54 and the appropriate service provider can return search results to a mobile terminal 10 via the federated search service 53 and the communications system of FIG. 2. Further, in some embodiments, a mobile terminal 10, and more particularly search application 36, may require a customized vertical search form prior to initiating a search request. In such cases, search application 36, or another application on mobile terminal 10 may request a customized vertical search form from the customizable mobile forms service 55 via federated search service 53. In some embodiments, the customized vertical search forms can be provided to customizable mobile forms service 55 by the service providers 54. Accordingly, customizable mobile forms service 55 may return a customized vertical search form to a mobile terminal 10 via the federated search service 53 and the communications system of FIG. 2.

Although not shown in FIG. 2, in addition to or in lieu of coupling the mobile terminal 10 to computing systems 52 and/or federated search service 53 across the Internet 50, the mobile terminal 10 and computing system 52 and/or the federated search service 53 may be coupled to one another and communicate in accordance with, for example, RF, BT, IrDA or any of a number of different wireline or wireless communication techniques, including LAN, WLAN, WiMAX, UWB techniques and/or the like. One or more of the computing system 52 and federated search service 53 can additionally, or alternatively, include a removable memory capable of storing content, which can thereafter be transferred to the mobile terminal 10. Further, the mobile terminal 10 can be coupled to one or more electronic devices, such as printers, digital projectors and/or other multimedia capturing, producing and/or storing devices (e.g., other terminals). Like with the computing system 52 and federated search service 53, the mobile terminal 10 may be configured to communicate with the portable electronic devices in accordance with techniques such as, for example, RF, BT, IrDA or any of a number of different wireline or wireless communication techniques, including universal serial bus (USB), LAN, WLAN, WiMAX, UWB techniques and/or the like.

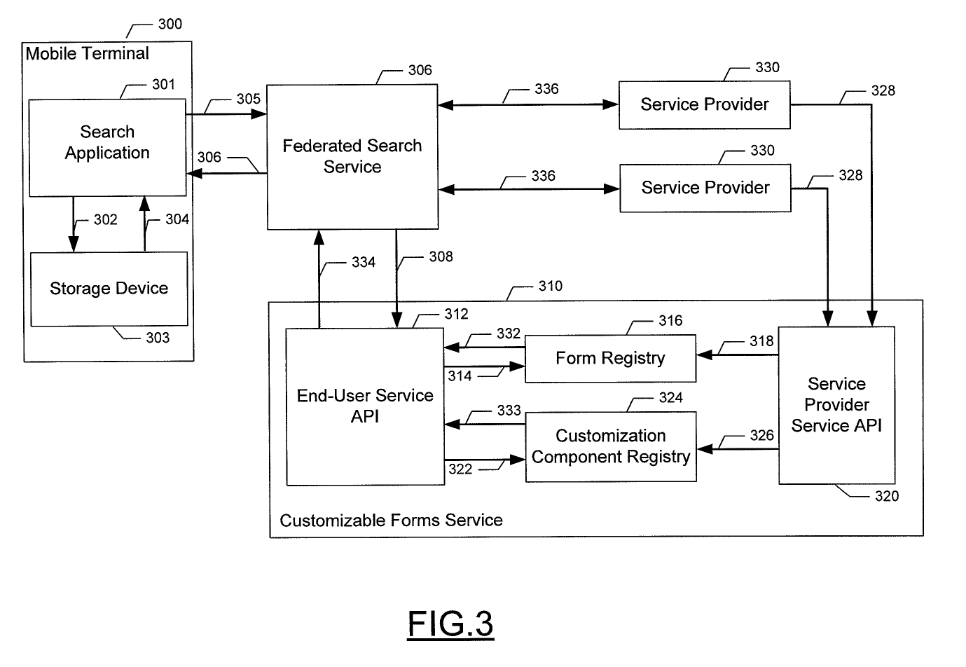

FIG. 3 depicts an exemplary block diagram of a customizable form service system which can be incorporated into, for example, the communications system of FIG. 2. The customizable form service system of FIG. 3 can include a mobile terminal 300, a federated search service 306, a customizable forms service 310, and service providers 330. The mobile terminal 300 can include a search application 301, and a storage device 303. The customizable forms service 310 can include an end-user service application program interface (API) 312, a form registry 316, a customization component registry 324, and a service provider service API 320.

Customizable forms service 310 can operate in the same manner as customizable mobile forms service 55 of FIG. 2. In this regard, customizable forms service 3 10 can operate as a holding and registration location for various customized vertical search forms that may be used in a vertical search on, for example, mobile terminal 300. Further, in some embodiments, one or more basic vertical search forms can be made available by the customizable forms service 310 to entities such as mobile terminal 300. A basic vertical search form can be a generic compilation of search parameter fields that are associated with a particular vertical. In addition to holding basic vertical search forms, the customizable forms service 310 can also hold forms that are customized by various service providers 330. Service providers 330 can operate in the same manner as service providers 54 of FIG. 2. Further, service providers, such as service providers 330, can customize a basic vertical search form to include, for example, additional search parameter fields, icons, logos, banners, links, etc. For example, a service provider 330 may customize a basic vertical search form to include the service provider's logo and links to other services that may be offered by the service provider. As such, a customized vertical search form can be linked to or associated with the service provider that customized the vertical search form. Therefore, when a device, such as mobile terminal 300, uses the customized vertical search form to conduct a search, performance of the search can be performed by the linked or associated service provider, and results from the search can be returned from the linked or associated search provider to, for example, mobile terminal 300.

After customizing a vertical search form, a service provider can register the customized vertical search form in the customizable form service 3 10. The service provider can register a customized vertical search form by interfacing with a service provider service API 320 of the customizable forms service 310 at 328. The service provider service API 320 can provide an interface between the service providers 330 and the customizable forms service 310, and more particularly the form registry 316 at 318 and the customization component registry 324 at 326. In some embodiments, the customized vertical search form can be separated into a basic vertical search form and customizations that are to be applied to the basic vertical search form to generate a customizable vertical search form. The service provider service API 320 can be used to register the basic vertical search form portion of the customized vertical search form with the form registry 3 16, and register the customizations and additions to the basic vertical search form associated with the customized vertical search form in the customization component registry 324. In some embodiments, one or more links or associations between the basic vertical search form and the customizations can be stored on in the form registry 316, the customization component registry 324, or some other entity. These links or associations can be used to combine the basic vertical search form with the customizations when the customized vertical search form is requested by a device. The combining of the basic vertical search form with the customization can occur on, for example, a mobile terminal, or the combination can be undertaken by a component of the customizable forms service. Further, in some embodiments, information with a request for a customized vertical search form can be utilized to retrieve the basic vertical search form and the customizations separately to be combined prior to use of the customized vertical search form.

The form registry 316 can maintain a registry of different vertical search forms associated with various verticals. In some embodiments, form registry 316 can also store basic vertical search forms and links or associations to customized vertical search forms, and the vertical search forms can be retrieved from form registry 316. In some embodiments, the basic vertical search forms and/or links or associations to customized vertical search forms may be stored in a separate storage server, and the forms registry 316 may include entries which can indicate how to retrieve the basic vertical search form from the separate storage server. In some embodiments, the entries can be pointers, addresses, or another type of indication of a location where the basic vertical search form is stored or how to retrieve the basic vertical search form. Further, in some embodiments, service providers can register basic vertical search forms that have been customized by the service provider in the form registry 316. Service providers can also associate or link the customized vertical search form to themselves as users of the forms in the form registry 316.

Customization component registry 324 can maintain a registry of customizations to customized vertical search forms associated with a particular service provider. In some embodiments, the customization component registry 324 can also impose customization guidelines on service providers to ensure that customized vertical search forms meet particular standards with respect to the vertical that is to be searched by the form. In some embodiments, customization component registry 324 can also store customization components, and the customization components can be retrieved from customization component registry 324. In some embodiments, the customization components and/or links or associations to customized vertical search forms may be stored in a separate storage server, and the customization component registry 324 may include entries which can indicate how to retrieve the customization components from the separate storage server. In some embodiments, the entries can be pointers, addresses, or another type of indication of a location where the customized are stored or how to retrieve the customizations. In this regard, the customized component registry 324 can maintain a registry of the additional search parameter fields, icons, logos, banners, links, a link or association to the service provider that customized the customized vertical search form, links or associations to customized vertical search forms or other customization components associated with a customized vertical search form.

In some embodiments, a service provider 330 can register a basic vertical search form with the form registry 316, and the customizations to that form in the customization component registry 324. Similarly, in some embodiments, a service provider 330 may customize an existing basic vertical form, and register the customizations to the basic vertical form in the customization component registry 324. Additionally, in a similar manner, service provider 330 may also update an existing customized vertical search form by registering a modification to an exiting form with the customized forms service 310 via the service provider service API 320. Upon registration of a customized vertical search form, the customized vertical search form can be made available for use in searching by for example, mobile terminal 300.

The mobile terminal 300 can be a device such as the mobile terminal 10 of FIGS. 1 and 2. Mobile terminal 300 can include a search application 301, the same as or similar to search application 36 as described above with respect to mobile terminal 10 of FIG. 1. The search application 301 may be any means, device or circuitry embodied in hardware, software, or a combination of hardware and software that is capable of conducting information searches using customized vertical search forms. Search application 301 or an application other than search application 301 but in communication with search application 301, such as a form manager, can maintain a listing of the available customized vertical search forms which can be used to perform a vertical search. In some embodiments, the listing of available customized search forms can be updated in the mobile terminal 300 at regular time intervals, when new forms are made available by the customizable forms service 310, as part of an initialization procedure of the search application 301 or the like. In some embodiments, the listing of available customized vertical search forms may be maintained on a webpage or an external server. In this regard, search application 301 or a form manager, can allow a user to select a customized vertical search form in order to initiate a vertical search. Search application 301 can receive the selection of a desired customized vertical search form, render the customized vertical search form, receive input into parameter fields and initiate the execution of a vertical search using the customized vertical search form. In this regard, in some embodiments, search application 301 or a form manager can interrogate storage device 303 to determine if a selected customizable search form is stored in storage device 303, and if it is stored in storage device 303, retrieve the selected customized vertical search form from storage device 303. Search application 301 or another application, may also manage customized vertical search forms by retrieving and storing the search forms in a storage device, such as storage device 303 which could be volatile memory 40 of mobile terminal 10 or non-volatile memory 42 of mobile terminal 10. In some embodiments, a separate application, such as a form manager application, can handle the management of search forms, i.e. retrieving, storing and updating of search forms. In this regard in some embodiments, search application 36 may still interact with the customized vertical search forms during the initiation of a search request.

The federated search service 306 can operate as an interface between the mobile terminal 300 and both the customizable forms service 310 and the service providers 330. The federated search service 306 can operate in a similar manner as federated search service 53 of FIG. 2. If in response to a selection of a customized vertical service form mobile terminal 300 needs to retrieve a customized vertical search form that currently is not stored on mobile terminal 300, or if it is determined that an updated customized vertical search form is available to be retrieved which may replace a customized vertical search form stored on mobile terminal 300, the federated search service 306 can provide mobile terminal 300 with an interface to the customizable forms service 310 to retrieve a customized vertical search form. In this regard, the federated search service 306 can interface with end-user service API 312 of the customizable forms service 310 and the end-user service API 312 can interrogate form registry 316 and customization component registry 324 to facilitate the retrieval of a customized vertical search form. As such, end-user service API 312 can provide an interface to retrieve or download customized vertical search forms to the mobile terminal 300 and, as such, search application 301.

Upon receipt of a customized vertical search form, the federated search service 306 can provide an interface between the mobile terminal 300 and the service provider associated with the selected customized vertical search form in order to initiate the search and return results to the mobile terminal 300. In this regard, in some embodiments, the federated search service 306 can support different interfaces with each service provider 330 where the same vertical is being searched, but different customized vertical search forms are being utilized.

Now referring to the cooperative operation of the entities of FIG. 3, the entities of FIG. 3 can operate to perform a customized vertical search and to manage customized vertical search forms on, for example, mobile terminal 300. With respect to performing a customized vertical search, in some embodiments, a user can select a customized vertical search form from a listing of available customized vertical search forms, via for example, search application 301. In response to receiving the selection of a customized vertical search form, search application 301 can interrogate storage device 303 at 302 to determine if the selected customized vertical search form is stored in storage device 303.

If the selected customized vertical search form is stored in storage device 303, then the customized vertical search form can be returned to the search application 301 at 304. In some embodiments, subsequent to determining that a selected customized vertical search form is stored in storage device 303, search application 301, or a form manager, can initiate a check of the form registry 316 and the customization component registry 324 via federated search service 306 and end-user service API 312 to determine if an update to the selected customized vertical search firm is available. If an update is available, the updated customized vertical search form can be retrieved and returned to mobile terminal 300. The updated customized vertical search form can then be stored in storage device 303 for future use. In some embodiments, an interrogation of storage device 303 may not be conducted and, in these embodiments, a customized vertical search form can be retrieved from the customizable forms service 310 each time a search is conducted.

In embodiments where the selected customized vertical search form is not currently stored in storage device 303, search application 301 or a form manager, can request the selected customized vertical search form. The request can be received by federated search service 306 at 305. Federated search service 306 can then interface with end-user service API 312 at 308 and end-user service API 312 can interrogate form registry 316 at 314 and customization component registry 324 at 322 to facilitate retrieval of the selected customized vertical search form by retrieving the associated basic vertical search form and the associated customizations at 332 and 334, respectfully. End-user service API 312 can then return the customized vertical search form, i.e. the combination of the basic vertical search form retrieved via the form registry 316 and the customization components retrieved via the customization component registry 324, to the federated search service 306 at 334. The federated search service can then return the customized vertical search form to the search application at 306. The customized vertical search form can also be stored in storage device 303 for future use.

Regardless of how search application 301 acquires the selected customized vertical search form, subsequent to the search application 301 receiving the customized vertical search form, search application 301 can render the form on the mobile terminal 300, such as on a display 28 of mobile terminal 10 of FIG. 1. Further, search application 301 can provide for receiving the entry of search parameters into search parameter fields on the customized vertical search form. The search parameters can be entered using, for example keypad 30 of mobile terminal 10 of FIG. 1. Subsequent to the entry of search parameters, a search request can be initiated by search application 301 causing data associated with the customized vertical search form, such as data regarding the vertical associated with the customized vertical search form, a link or association to a particular service provider and/or the entered search parameters, to be sent to the federated search service 306 at 305. The federated search service 306 can then interpret the request and direct the data associated with the customized vertical search form to the appropriate service provider 330 at 336.

The service provider 330 can then perform the vertical search using the data associated with the customized vertical search form and return the results of the search to the federated search service 306 at 336. The federated search service 306 can then return the results to search application 301 at 306. Search application 301 can then render the results and provide for inspection of the results by a user.

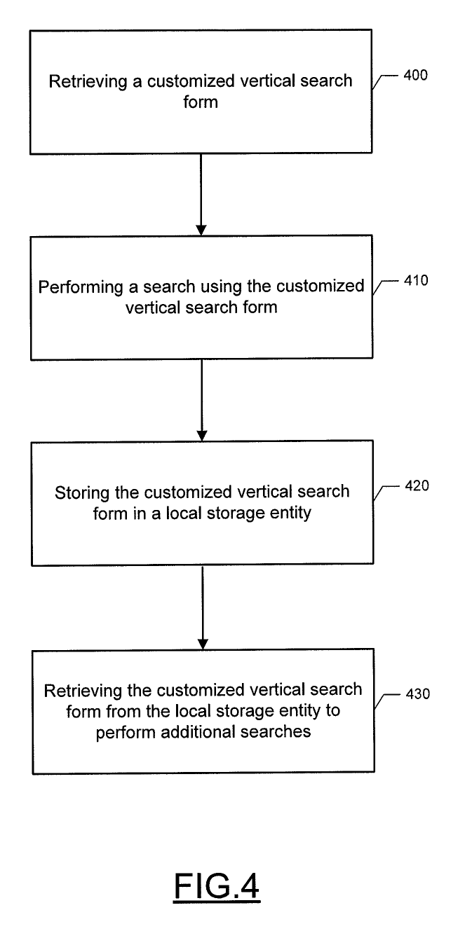

FIG. 4 depicts a method of performing a vertical search using a customized vertical search form according to various embodiments of the invention. The method can include retrieving a customized vertical search form at 400, performing a search using the customized vertical search form at 410, storing the customized vertical search form in a local storage entity at 420 and retrieving the vertical search form from the local storage entity to perform additional searches at 430.

A customized vertical search form can be retrieved at 400. In various embodiments, the customized vertical search form can be typically retrieved by a mobile terminal. The customized vertical search form can include one or more search parameter fields relating to a topic or category defined by a vertical associated with the customized vertical search form. The customized vertical search form can be customized by a service provider and made available for use via a customizable forms service, such as the customizable forms service 310 of FIG. 3 or the customizable mobile form service 55 of FIG. 2.

Further, the customized vertical search form can be retrieved from a storage entity such as the storage device 303 of FIG. 3, volatile memory 40 of FIG. 1 or non-volatile memory 42 of FIG. 1. In some embodiments, the customized vertical search form can be retrieved from a customizable forms service, such as the customizable forms service 3 10 of FIG. 3 or the customizable mobile form service 55 of FIG. 2. In some embodiments, a form registry and a customization component registry can be utilized to facilitate retrieval of a customizable vertical search form. In this regard, the form registry can store entries associated with vertical search forms for facilitating retrieval of a vertical search form. Similarly, the customization component registry can store entries associated with customizations of vertical search forms for facilitating retrieval of the customizations of a vertical search form.

A search using the customized vertical search form can be performed at 410. The search can be performed by requesting, typically by a mobile terminal, search results from a service provider that is linked to or associated with the customized vertical search form. The results can be based upon data entered into the search parameter fields and the vertical associated with the vertical search form. Further, link or association data can be used to identify the service provider from which result can be requested. In some embodiments, the results can be returned to requesting device, such as, for example, mobile terminal 10 or mobile terminal 300.

Further, in some embodiments, the customized vertical search form can be stored in a local storage entity at 420. The customized vertical search form can be stored in the local storage entity, such as the storage device 303 of FIG. 3, volatile memory 40 of FIG. 1 or non-volatile memory 42 of FIG. 1. As a result of the local storage, future utilization of the customizable vertical search from can be undertaken without retrieving the customizable vertical search form from the customizable mobile forms service. Accordingly, at 430, the vertical search form can be retrieved from the local storage entity to perform additional searches.

FIG. 4 is a flowchart of a method according to exemplary embodiments of the invention. It will be understood that each block or step of the flowcharts, and combinations of blocks in the flowcharts, can be implemented by various means, such as hardware, firmware, and/or software including one or more computer program instructions. For example, one or more of the procedures described, such as those related to the search application, retrieval of a customized vertical search form, registration of a customized vertical search form may be embodied by computer program instructions. As will be appreciated, any such computer program instructions may be loaded onto a computer or other programmable apparatus (i.e., hardware), such as the processor terminal of a mobile terminal, a processing element associated with a federated search service, a customizable forms service, or a service provider, to produce a machine, such that the instructions which execute on the computer or other programmable apparatus create means for implementing the functions specified in the flowcharts block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowcharts block(s) or step(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowcharts block(s) or step(s).

Accordingly, blocks or steps of the flowcharts support combinations of means for performing the specified functions, combinations of steps for performing the specified functions and program instruction means for performing the specified functions. It will also be understood that one or more blocks or steps of the flowcharts, and combinations of blocks or steps in the flowcharts, can be implemented by special purpose hardware-based computer systems which perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method comprising:
retrieving a customized vertical search form which originated with a customizable forms service following customization by a service provider, the customized vertical search form including one or more search parameter fields relating to a topic or category defined by a vertical associated with the customized vertical search form; and
performing a search using the customized vertical search form, the search being performed by requesting search results from the service provider based on data entered into the search parameter fields, the vertical associated with the customized vertical search form and an indication of an association between the customized vertical search form and the service provider.

2. The method of claim 1, wherein retrieving a customized vertical search form further comprises retrieving a customized vertical search form from the customizable forms service, wherein retrieving a customized vertical search form from the customizable forms service further comprises:
retrieving a basic vertical search form from a form registry,
retrieving one or more customizations from a customization component registry, and
combining the basic vertical search form and the one or more customizations to create the customized vertical search form.

3. The method of claim 2, further comprising:
storing the retrieved customized vertical search form in a local storage entity; and
retrieving the customized vertical search form from the local storage entity to perform additional searches.

4. The method of claim 2, further comprising:
storing the retrieved customized vertical search form in a local storage entity;
determining if an updated customized vertical search form has been made available by the service provider via the customizable forms service prior to retrieving the customized vertical search form; and
retrieving an updated customized vertical search form from the customizable forms service if an updated customized vertical search form has been made available.

5. The method of claim 2, wherein retrieving a customized vertical search form further comprises retrieving a customized vertical search form from the customizable forms service, the customizable forms service receiving the customized vertical search form via a service provider service application program interface.

6. An apparatus comprising a processor configured to:
retrieve a customized vertical search form which originated with a customizable forms service following customization by a service provider, the customized vertical search form including one or more search parameter fields relating to a topic or category defined by a vertical associated with the customized vertical search form; and
perform a search using the customized vertical search form, the search being performed by requesting search results from the service provider based on data entered into the search parameter fields, the vertical associated with the customized vertical search form and an indication of an association between the customized vertical search form and the service provider.

7. The apparatus of claim 6 wherein the processor is further configured to retrieve a customized vertical search form by being configured to;
retrieve a basic vertical search form from a form registry,
retrieve one or more customizations from a customization component registry, and
combine the basic vertical search form and the one or more customizations to create the customized vertical search form.

8. The apparatus of claim 7, wherein the processor is further configured to:
store the retrieved customized vertical search form in a local storage entity; and
retrieve the customized vertical search form from the local storage entity to perform additional searches.

9. The apparatus of claim 7, wherein the processor is further configured to:
store the retrieved customized vertical search form in a local storage entity;
determine if an updated customized vertical search form has been made available by the service provider via the customizable forms service prior to retrieving the customized vertical search form; and
retrieve an updated customized vertical search form from the customizable forms service if an updated customized vertical search form has been made available.

10. The apparatus of claim 7, wherein the processor is further configured to retrieve a customized vertical search form by retrieving a customized vertical search form from the customizable forms service, the customizable forms service receiving the customized vertical search form via a service provider service application program interface.

11. A computer-readable storage medium having computer-readable program code portions stored therein, the computer-readable program code portions comprising:
a first executable portion configured to retrieve a customized vertical search which originated with a customizable forms service following customization by a service provider, the customized vertical search form including one or more search parameter fields relating to a topic or category defined by a vertical associated with the customized vertical search form, the customized vertical search form being customized by a service provider and made available for use via a customizable forms service; and
a second executable portion configured to perform a search using the customized vertical search form, the search being performed by requesting search results from the service provider based on data entered into the search parameter fields, the vertical associated with the vertical search form and an indication of an association between the customized vertical search form and the service provider.

12. The computer-readable storage medium of claim 11 wherein the first executable portion further comprises retrieving a customized vertical search form from the customizable forms service, wherein retrieving a customized vertical search form from the customizable forms service further comprises:
retrieving a basic vertical search form from a form registry,
retrieving one or more customizations from a customization component registry, and
combining the basic vertical search form and the one or more customizations to create the customized vertical search form.

13. The computer-readable storage medium of claim 12 further comprising:
a third executable portion configured to store the retrieved customized vertical search form in a local storage entity; and
a fourth executable portion configured to retrieve the customized vertical search form from the local storage entity to perform additional searches.

14. The computer-readable storage medium of claim 12 further comprising:
a third executable portion configured to store the retrieved customized vertical search form in a local storage entity;
a fourth executable portion configured to determine if an updated customized vertical search form has been made available by the service provider via the customizable forms service prior to retrieving the customized vertical search form; and
a fifth executable portion configured to retrieve an updated customized vertical search form from the customizable forms service if an updated customized vertical search form has been made available.

15. The computer-readable storage medium of claim 12, wherein the first executable portion is further configured to retrieve a customized vertical search form by retrieving a customized vertical search form from the customizable forms service, the customizable forms service receiving the customized vertical search form via a service provider service application program interface.

16. An apparatus comprising:
a form registry for storing one or more entries associated with a customized vertical search form to facilitate retrieval of a basic vertical search form associated with the customized vertical search form, the customized vertical search form including one or more search parameter fields relating to a topic or category defined by a vertical associated with the customized vertical search form; and
a customization component registry for storing one or more entries associated with the customized vertical search form to facilitate retrieval of one or more customizations associated with the customized vertical search form.

17. The apparatus of claim 16 further comprising:
a mobile terminal, the mobile terminal for retrieving the customized vertical search form;
a service provider that customizes the customized vertical search form and makes the customized vertical search form available via the form registry and the customization component registry.

18. The apparatus of claim 17, wherein the mobile terminal further comprises:
a search application that requests and receives customized vertical search forms; and
a storage device where received customized vertical search forms can be stored for use in future searches.

19. The apparatus of claim 16 further comprising:
an end-user service application program interface that facilitates communications to both the form registry and the customization component registry for providing new and updated customized vertical search forms; and
a service provider service application program interface that facilitates communications to both the form registry and the customization component registry to register the customized vertical search form into the form registry and the customization component registry.

20. A method comprising:
receiving a request from a requesting device for a customized vertical search form, the customized vertical search form including one or more search parameter fields relating to a topic or category defined by a vertical associated with the customized vertical search form, the customized vertical search form being customized by a service provider and made available for use via a customizable forms service;
querying a form registry to determine if the requested customized vertical search form is stored within the customizable forms service;
retrieving a basic vertical search form associated with the customized vertical search form from the customizable forms service;
retrieving one or more customized components associated with the requested customized vertical search form from the customizable forms service, the basic vertical search form and the customized components comprising the customized vertical search form; and
providing for transmission of the requested customized vertical search form to the requesting device.

21. The method of claim 21 further comprising:
receiving the customized vertical search form the service provider;
storing the customized vertical search form in the customizable forms service; and
updating the form registry with an entry associated with the customized vertical form;
wherein receiving the customized vertical search form, storing the customized vertical search form and updating the form registry occur prior to receiving a request from the requesting device.
